(19) United States
(12) Patent Application Publication
(10) Pub. No.: US 2020/0158894 A1
(43) Pub. Date: May 21, 2020

(54) X-RAY DETECTOR HAVING A STACK ARRANGEMENT

(71) Applicant: Siemens Healthcare GmbH, Erlangen (DE)

(72) Inventor: Thorsten ERGLER, Erlangen (DE)

(73) Assignee: Siemens Healthcare GmbH, Erlangen (DE)

(21) Appl. No.: 16/669,718

(22) Filed: Oct. 31, 2019

(30) Foreign Application Priority Data
Nov. 15, 2018 (DE) 102018219577.3

(51) Int. Cl. G01T 1/24

(52) U.S. Cl. CPC G01T 1/242

(57) ABSTRACT

An X-ray detector unit includes a first stack layer and a second stack layer in a stack arrangement. In an embodiment, the first stack layer includes a converter element to convert incident X-rays into an electrical signal, and includes first electrically conductive contact elements on a contact side facing the second stack layer, in a first number density per unit surface area. The second stack layer includes second electrically conductive contact elements on a counter-contact side facing the first stack layer, of the second stack layer, in a second number density per unit surface area. The first number density is greater than the second number density and each of the second electrically conductive contact elements makes electrically conductive contact with a plurality of first electrically conductive contact elements.

### PRIORITY STATEMENT

The present application hereby claims priority under 35 U.S.C. § 119 to German patent application number DE 102018219577.3 filed Nov. 15, 2018, the entire contents of which are hereby incorporated herein by reference.

### FIELD

Embodiments of the invention generally relate to an X-ray detector unit, an X-ray device and a method for manufacturing an X-ray detector unit having a stack arrangement.

### BACKGROUND

In X-ray imaging, for example in computed tomography, angiography, mammography or radiography, numerous direct-conversion X-ray detectors or integrating indirect-conversion X-ray detectors can be used.

In direct-conversion X-ray detectors, the X-rays or photons can be converted into electrical pulses by a suitable converter material. Possible converter materials are for example CdTe, CZT, CdZnTeSe, CdTeSe, CdMnTe, InP, TlBr₂, HgI₂, GaAs or other materials. The electrical pulses are evaluated by an evaluation electronics unit, for example an integrated circuit (application specific integrated circuit, ASIC). In numerous X-ray detectors, incident X-rays are measured by counting the electrical pulses triggered by the absorption of X-ray photons in the converter material. Typically, the amplitude of the electrical pulse is proportional to the energy of the absorbed X-ray photon. As a result, information regarding the spectrum can be inferred from comparing the amplitude of the electrical pulse with a threshold value. The evaluation unit can be provided with so-called through silicon vias (TSVs), with the result that these pass the signals or numerical values processed in the evaluation unit—in particular digital signals or numerical values—on the side remote from the converter element to a base substrate in which rerouting is performed and the—in particular digital—signals can be detected through a connector by way of a ribbon cable.

In indirect-conversion X-ray detectors, the X-rays or photons can be converted into light by a suitable converter material and into electrical pulses via photodiodes. Frequently, scintillators are used as the converter material, for example GOS (Gd₂O₂S), CsJ, YGO or LuTAG. Scintillators are used in particular in medical X-ray imaging in the energy range up to 1 MeV. Conventionally, so-called indirect-conversion X-ray detectors, so-called scintillator detectors, are used in which X-rays or gamma rays are converted into electrical signals in two stages. In a first stage, the X-ray or gamma quanta are absorbed in a scintillator element and converted into visible light, an effect called luminescence. The light excited by luminescence is then, in a second stage, converted into an electrical signal by a first photodiode that is optically coupled to the scintillator element, and this electrical signal is output by way of an evaluation or reader electronics unit and then passed on to a processor unit.

Direct-conversion X-ray detectors are usually constructed in a stack, with the associated evaluation unit mounted on the underside of a layer of the converter material. Arranged between the evaluation unit and the converter unit there may additionally be an intermediate layer, an interposer, which can serve for stability or indeed to divert signal lines. Conventionally, a plurality of image elements (pixels) in the form of metallized contact elements is mounted on the underside of the converter unit. These are used to make contact—conventionally being soldered—with the evaluation unit or the interposer such that signals are transferred. Conventionally in this case, there is placed opposite a contact element on the converter side a counter-contact element on the side with the evaluation unit or the interposer. When the stack is constructed, in particular the contacts of the converter element and the counter-contacts of the evaluation unit or interposer must be aligned with one another such that a contact element on the converter side is in each case brought into electrically conductive contact with a counter-contact element. A faulty contact—that is to say if a contact element on the converter side is not brought into contact with a counter-contact element—may result in defective pixels and irregularities in the pixel matrix that may impair the quality and resolution of the resulting images.

In order to prevent faulty contacts in a conventional construction, the pixels on the sensor matrix—that is to say typically the contact elements on the converter side—and the pixels of individual connection elements on the evaluation unit or interposer must therefore be aligned with one another very precisely during assembly. Moreover, high demands have to be made of the precise form taken by the contact elements. In particular when manufacturing large-area detectors having sensor layers of a large surface area, for example 20×20 cm, inaccuracies, assembly tolerances or similar may have a cumulative effect over the relatively large distances and make it more difficult to make contact or result in faulty contacts. Likewise, if the sensor layer is composed of a plurality of converter elements, faulty contacts may arise—for example of whole rows or columns—in particular at the points of abutment between two converter elements.

In that case, the smaller the pixel size of the detector and hence also the contact elements are to be, the higher the demands. For example, for an application in mammography with a pixel size of 75 μm, as is the aim in mammography, this would mean that all the contacts on a sensor matrix 20'20 cm would need to be processed and aligned with an absolute accuracy of approximately 25 μm.

The published application DE 10 2014 221 829 A1 discloses a method for manufacturing a sensor board for a detector module, wherein a plurality of reader units is provided, wherein the reader units are positioned in a stacked construction, each on a common sensor layer, and wherein, after all the reader units have been positioned, they are fixed in position together on the sensor layer, forming a hybrid.

The unpublished application DE 10 2018 200 845 A1 discloses an assembly method for manufacturing an X-ray detector, wherein a plurality of sensor surface elements made from an X-ray-sensitive material is positioned on a mounting support and an interposer is laid on a contact side of each sensor surface element, this contact side being opposed to the mounting support and divided into a plurality of pixels, such that contact elements arranged on a counter-contact side of the interposer facing the sensor surface elements each make contact with a respective pixel.

### SUMMARY

At least one embodiment of the invention provides an X-ray detector unit, an X-ray device having an X-ray detector unit, and/or a method for manufacturing an X-ray detector unit which enable improved X-ray imaging.

Advantageous developments of the invention form the subject-matter of dependent claims and the description below.

At least one embodiment of the invention relates to an X-ray detector unit including a first stack layer and a second stack layer in a stack arrangement, wherein

the first stack layer includes a converter element that is intended to convert incident X-rays into an electrical signal,
the first stack layer has first electrically conductive contact elements on a contact side facing the second stack layer, in a first number density per unit surface area,
the second stack layer has second electrically conductive contact elements on a counter-contact side, facing the first stack layer, of the second stack layer, in a second number density per unit surface area,
the first number density is greater than the second number density, and
each of the second electrically conductive contact elements makes electrically conductive contact with a plurality of first electrically conductive contact elements.

Moreover, at least one embodiment of the invention relates to an X-ray device having an X-ray detector unit according to at least one embodiment of the invention. For example, the X-ray device may be a medical X-ray device. For example, the X-ray device comprises a mammography or an angiography X-ray device or similar. For example, the X-ray device comprises a C-frame X-ray device. The X-ray device may also comprise a computed tomography device.

The X-ray device according to at least one embodiment of the invention, for example a C-frame X-ray device, has the above-described X-ray detector unit. In this way, the X-ray device according to at least one embodiment of the invention also shares the features and advantages described above in the context of the X-ray detector unit.

Furthermore, at least one embodiment of the invention relates to a method for manufacturing an X-ray detector unit having a first stack layer and a second stack layer in a stack arrangement, wherein the first stack layer includes a converter element intended to convert incident X-rays into an electrical signal, including the steps of positioning and bringing into contact.

Furthermore, at least one embodiment of the invention relates to an X-ray detector unit, comprising:

a first stack layer; and
a second stack layer, the first stack layer and the second stack layer being in a stack arrangement, wherein
the first stack layer includes a converter element to convert incident X-rays into an electrical signal,
the first stack layer includes first electrically conductive contact elements arranged on a contact side facing the second stack layer, in a first number density per unit surface area,
the second stack layer includes second electrically conductive contact elements arranged on a counter-contact side, facing the first stack layer, of the second stack layer, in a second number density per unit surface area, the first number density being relatively greater than the second number density, and
each of the second electrically conductive contact elements being configured to make electrically conductive contact with a plurality of the first electrically conductive contact elements.

Furthermore, at least one embodiment of the invention relates to a method for manufacturing an X-ray detector unit including a first stack layer including a converter element to convert incident X-rays into an electrical signal, and a second stack layer, the first stack layer and the second stack layer being arranged in a stack arrangement, the method comprising:
positioning the first stack layer, the first stack layer including first electrically conductive contact elements on a contact side in a first number density per unit surface area, and the second stack layer, the second stack layer including second electrically conductive contact elements on a counter-contact side in a second number density per unit surface area, the first number density being relatively greater than the second number density, such that the contact side of the first stack layer and the counter-contact side of the second stack layer run parallel and face one another;
bringing into contact the second stack layer and the first stack layer such that each electrically conductive contact element of the second electrically conductive contact elements makes electrically conductive contact with a plurality of first electrically conductive contact elements.

### BRIEF DESCRIPTION OF THE DRAWINGS

Example embodiments of the invention will be explained in more detail below with reference to drawings, in which:

In the drawings:

FIG. 1 schematically shows a stack arrangement in an X-ray detector unit in a first embodiment, in a condition of being assembled,

FIG. 2 schematically shows the stack arrangement of the X-ray detector unit in the first embodiment, in an assembled condition,

FIG. 3 schematically shows a detail of a stack arrangement of an X-ray detector unit in a second embodiment,

FIG. 4 schematically shows a stack arrangement of an X-ray detector unit in a third embodiment,

FIG. 5 schematically shows a stack arrangement of an X-ray detector unit in a fourth embodiment,

FIG. 6 schematically shows the sequence of a method for manufacturing an X-ray detector unit in a first embodiment,

FIG. 7 schematically shows the sequence of a method for manufacturing an X-ray detector unit in a second embodiment, and

FIG. 8 schematically shows a medical X-ray device.

### DETAILED DESCRIPTION OF THE EXAMPLE EMBODIMENTS

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Various example embodiments will now be described more fully with reference to the accompanying drawings in which only some example embodiments are shown. Specific structural and functional details disclosed herein are merely representative for purposes of describing example embodiments. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated. The present invention, however, may be embodied in many alternate forms and should not be construed as limited to only the example embodiments set forth herein.

It will be understood that, although the terms first, second, etc. may be used herein to describe various elements, components, regions, layers, and/or sections, these elements, components, regions, layers, and/or sections, should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items. The phrase “at least one of” has the same meaning as “and/or”.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Also, the term “example” is intended to refer to an example or illustration.

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,” another element there are no intervening elements present.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Before discussing example embodiments in more detail, it is noted that some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Specific structural and functional details disclosed herein are merely representative for purposes of describing example embodiments of the present invention. This invention may, however, be embodied in many alternate forms and should not be construed as limited to only the embodiments set forth herein.

Units and/or devices according to one or more example embodiments may be implemented using hardware, software, and/or a combination thereof. For example, hardware devices may be implemented using processing circuity such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner. Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor, Central Processing Unit (CPU), a controller, an arithmetic logic unit (ALU), a digital signal processor, a microcomputer, a microprocessor, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including the tangible or non-transitory computer-readable storage media discussed herein.

Even further, any of the disclosed methods may be embodied in the form of a program or software. The program or software may be stored on a non-transitory computer readable medium and is adapted to perform any one of the aforementioned methods when run on a computer device (a device including a processor). Thus, the non-transitory, tangible computer readable medium, is adapted to store information and is adapted to interact with a data processing facility or computer device to execute the program of any of the above mentioned embodiments and/or to perform the method of any of the above mentioned embodiments.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as a computer processing device or processor; however, one skilled in the art will appreciate that a hardware device may include multiple processing elements or processors and multiple types of processing elements or processors. For example, a hardware device may include multiple processors or a processor and a controller. In addition, other processing configurations are possible, such as parallel processors.

The computer programs include processor-executable instructions that are stored on at least one non-transitory computer-readable medium (memory). The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc. As such, the one or more processors may be configured to execute the processor executable instructions.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

Further, at least one embodiment of the invention relates to the non-transitory computer-readable storage medium including electronically readable control information (processor executable instructions) stored thereon, configured in such that when the storage medium is used in a controller f a device, at least one embodiment of the method may be carried out.

The computer readable medium or storage medium may be a built-in medium installed inside a computer device main body or a removable medium arranged so that it can be separated from the computer device main body. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

At least one embodiment of the invention relates to an X-ray detector unit including a first stack layer and a second stack layer in a stack arrangement, wherein

the first stack layer includes a converter element that is intended to convert incident X-rays into an electrical signal,
the first stack layer has first electrically conductive contact elements on a contact side facing the second stack layer, in a first number density per unit surface area,
the second stack layer has second electrically conductive contact elements on a counter-contact side, facing the first stack layer, of the second stack layer, in a second number density per unit surface area,
the first number density is greater than the second number density, and
each of the second electrically conductive contact elements makes electrically conductive contact with a plurality of first electrically conductive contact elements.

The X-ray detector unit may preferably be a direct-conversion or quantum-counting, or a counting X-ray detector.

The first stack layer may be designated the sensor plane or sensor layer, including a converter element, also called a sensor element. The first stack layer may in this case also include a plurality of converter elements.

The converter element of the first stack layer may take a planar form - that is to say have a planar extent. The surface normal to the planar extent of the converter element may preferably run substantially parallel to the direction of incidence of the X-rays. For example, the converter element comprises a converter material that is intended to convert an incident X-ray quantum that is absorbed in the converter material into an electrical signal. For example, the converter material comprises a material from the group composed of CdTe, CZT, CdZnTeSe, CdTeSe, CdMnTe, InP, TlBr₂, HgI₂, GaAs or other materials.

The second stack layer may take the form of an evaluation layer, including an evaluation unit. In a second stack layer taking the form of an evaluation layer, the evaluation unit may be intended to evaluate the electrical pulses or electrical signals that are generated in the converter element by the X-rays, or to process them in the manner of signals. In this case, the evaluation unit may preferably take the form of an ASIC. Moreover, an evaluation unit of this kind may in particular have a planar extent. The planar extent of the evaluation unit may correspond to the planar extent of the converter element. However, it may also be smaller or larger.

A second stack layer in the form of an evaluation layer may likewise include a plurality of evaluation units. In this case, an integer number of evaluation units may be associated with one converter element. For example, one, two or four evaluation units may be associated with one converter element.

The second stack layer may, however, also include as an intermediate layer an interposer element—that is to say an intermediate unit. The intermediate layer may accordingly also be designated the interposer layer. The intermediate layer may be formed between the first stack layer—that is to say the sensor plane—and a downstream evaluation unit or evaluation plane. In the configuration of the second stack layer as an intermediate layer, electrically conductive connections between the second contact elements and the input channels of a downstream evaluation unit may moreover be formed within the second stack layer. The interposer element may comprise for example glass, silicon, or rigid or flexible printed circuit board material. Advantageously, an interposer element may improve the stability of the stack construction.

In a second stack layer taking the form of an intermediate layer, an interposer element may have substantially the same planar extent as the converter element. However, the interposer element may also have a different planar extent. For example, the planar extent of an interposer element may be larger than the planar extent of a converter element. A second stack layer taking the form of an intermediate plane may include a plurality of interposer elements.

The stacking direction of the stack arrangement comprising the first and the second stack layer may in particular be oriented substantially parallel to the direction of incidence of the X-rays in operation. This means that the planar extent of the first stack layer and the planar extent of the second may be formed in each case perpendicular to the direction of incidence of the X-rays in operation and substantially parallel to one another.

Moreover, in addition to the first and second stack layers, the X-ray detector unit may also include further layers. For example, it is conceivable for the X-ray detector unit moreover to have a substrate or a support unit on which the stack arrangement may be arranged. An additional support unit may serve for stability. However, it may also comprise further functional elements for operation of the X-ray detector unit.

The effect of the first and second electrically conductive contact elements is that an electrically conductive connection between the first and the second stack layer in the stack arrangement is made possible in the stack arrangement. The electrically conductive connection—that is to say the making of contact—may enable signal transfer, of an electrical signal resulting from the absorption of an X-ray quantum in the converter element, from the first stack layer to the second stack layer.

For example, the first and/or second electrically conductive contact elements comprise copper, gold and/or platinum.

The first and/or second contact elements may in particular be mounted by lithography or mechanically. For example, the second contact elements may take the form of so-called stud bumps. The second contact elements may also take the form of pillars, for example so-called copper pillars, which are formed by substantially metal cylinders (or pillars). In particular, very precise manufacture of the contact elements may be made possible by a lithographic manufacturing procedure. In particular, this also makes it possible to manufacture contact elements having a small contact surface area particularly simply.

In particular, the first number density per unit surface area of the first electrically conductive contact elements on the contact side of the first stack layer is greater than the second number density of the second electrically conductive contact elements on the counter-contact side. The term “a number density per unit surface area” may be understood to mean the number of contact elements per unit surface area. For example, the number density may be expressed as the average number of contact elements per 1 cm\hat{ }2 or the average number of contact elements per 1 mm\hat{ }2.

For example, the first stack layer may have a number density per unit surface area of first electrically conductive contact elements that is at least twice as great as that of second contact elements on the second stack layer. Preferably, however, the first number density is at least 4 times as great as the second number density. More preferably, the first number density is between 10 and 200 times as great as the second number density of the second stack layer.

Here, the first contact elements preferably have a uniform spatial distribution, at least within the planar extent of a converter element. The spatial arrangement of the first contact elements, at least within the planar extent of the converter element, may comprise a fixed, regular grid pattern, for example a square, rectangular or other type of grid pattern. However, they need not necessarily comprise a fixed grid pattern. The first contact elements may be evenly distributed substantially at random, without a fixed grid pattern.

Here, each contact element of the first electrically conductive contact elements has a first contact surface facing the second stack layer, and each contact element of the second electrically conductive contact elements has a second contact surface facing the first stack layer. The contact surface of a contact element is substantially in each case the surface of the contact element that faces the respectively opposing stack layer in the stack arrangement. The first and the second contact surface may take the same form. Preferably, however, the first and the second contact surface may also take different forms. For example, the first contact surface is smaller than the second contact surface.

In particular, the contact elements are formed on the contact side and the counter-contact side respectively such that, in the stack arrangement of the X-ray detector unit according to at least one embodiment of the invention, each of the second electrically conductive contact elements makes contact with a plurality of first electrically conductive contact elements.

The number of first electrically conductive contact elements brought into contact for each second electrically conductive contact element may vary as far as the second electrically conductive contact elements are concerned. The number may, however, also be the same for each second electrically conductive contact element. In addition to first electrically conductive contact elements that are brought into contact, the X-ray detector unit according to at least one embodiment of the invention may moreover have first electrically conductive contact elements that are not brought into contact with second electrically conductive contact elements in the stack arrangement.

In a quantum-counting X-ray detector unit, typically an evaluation region of an evaluation unit—that is to say a so-called ASIC pixel—may be associated with a respective detector element—that is to say a pixel. In the X-ray detector unit according to the invention, an ASIC pixel of this kind, or its input channel, may be electrically conductively connected to the converter element by way of a respective second contact element. The volume (or surface area) of the converter element that is associated with a detector element—that is to say a pixel—or in other words the sensor pixel associated with an ASIC pixel—may then be based substantially on the plurality of first electrically conductive contact elements that is connected to a contact element of the second electrically conductive contact elements.

With the X-ray detector unit according to at least one embodiment of the invention, it is advantageously possible to construct an X-ray detector unit in which in particular a plurality of first contact elements is available for making contact with a second contact element. This advantageously allows a stack arrangement of an X-ray detector unit to be produced, wherein an electrically conductive contact can be reliably made between the first stack layer and the second stack layer in an improved manner. Advantageously, faulty contacts may be reduced or even completely avoided. Inaccuracies in the positioning or manufacture of contact elements or during assembly of the stack arrangement, caused for example by manufacturing tolerances, may be compensated in an improved manner. In particular, making one-to-one contact between a contact element on the converter side and a counter-contact element on the evaluation or interposer side, and the necessity this entails of a very high degree of precision in manufacture and alignment, can be avoided or at least reduced. Advantageously, this enables cost-effective manufacture, since the demands made of manufacture and assembly can potentially be reduced by comparison with one-to-one assembly of the contact elements.

Advantageously, moreover a flexible configuration of the pixel matrix may be made possible. For example, by adapting the size and configuration of the second electrically conductive contact elements, the number of first electrically conductive contact elements that is respectively brought into contact can be adapted. As a result, for example different sizes of pixel sizes may be produced without changing the design of the first stack layer.

According to a preferred variant embodiment of the X-ray detector unit according to at least one embodiment of the invention, two adjacent second electrically conductive contact elements are at a spacing from one another that is greater than a maximum width of the first contact surface of the first electrically conductive contact elements into this spacing. Advantageously, it is possible to avoid making a double contact between a first contact element and two second electrically conductive contact elements.

According to a particularly preferred variant embodiment of the X-ray detector unit according to at least one embodiment of the invention, two adjacent first electrically conductive contact elements are at a spacing from one another that is smaller than a maximum width of the second contact surface of the second electrically conductive contact elements into this spacing. Particularly advantageously, in this way it is possible to avoid faulty contacts between the first and the second stack layer.

In a further preferred variant of the X-ray detector unit of at least one embodiment, the first contact surface of the first electrically conductive contact elements is smaller than the second contact surface of the second electrically conductive contact elements.

Advantageously, in this way, and particularly favorably, inaccuracies in positioning or manufacture can be identified and prevented in steps that are of smaller gradation on the converter side. Advantageously, a particularly uniform pixel matrix can be produced within an X-ray detector unit. Moreover, a configuration of this kind enables a particularly flexible determination of pixel sizes, in particular also relatively small pixel sizes.

According to an X-ray detector unit of at least one embodiment of the invention, the electrically conductive contact between the first electrically conductive contact elements and the second electrically conductive contact elements is made here without soldering. Preferably, the electrical contact is made by mechanical contact, for example by pressing the pixels and the associated contact elements against one another. As a result of dispensing with a soldering procedure between the first and second stack layer, it is possible to avoid, or at least to significantly reduce, influence on a positioning tolerance as a result of displacements caused by the soldering procedure, or similar. However, it is also possible for the electrically conductive connection between the first and the second stack arrangement to be made as a solder connection or conductive adhesive connection.

Between the first stack layer and the second stack layer and the electrically conductive connections arranged between them, there may be formed in the stack arrangement an intermediate space or a plurality of intermediate spaces or gaps. In a preferred variant of the X-ray detector unit, this intermediate space between the first stack layer and the second stack layer is filled with a filling material.

Here, the filling material may serve, in the form of an adhesive between the first stack layer and the second stack layer, to mechanically stabilize the making of contact between the stack layers. Advantageously, the effective forces from the individual electrical connections can be reduced and distributed over the surface. The filling material may comprise an epoxy compound, a synthetic material, a composite material or a (pre-)polymer. The filling material may comprise a binder. It may take the form of a matrix of binder and filling material. The filling material may in particular comprise an epoxy resin. The filling material may in particular be electrically insulated or non-conductive.

In a preferred variant of the X-ray detector unit, an evaluation unit associated with the converter element is arranged on an opposite side of the second stack layer to the counter-contact side. The evaluation unit preferably takes the form of an ASIC and is intended to evaluate the electrical signals formed in the converter element by the incident X-rays. The evaluation unit may be connected to the interposer element for example by solder connections or an electrically conductive adhesive connection. In this variant embodiment, the second stack layer serves in particular as an intermediate layer, comprising an interposer element, wherein the signals are passed to the input channels of the evaluation unit by the second contact elements via electrical connections within the interposer element.

The planar extent of the evaluation unit may in this case substantially correspond to the planar extent of the converter element, and the electrically conductive connections within the interposer element may substantially provide a passage through, or a making of contact, from the second electrically conductive contact elements to the input channels of the evaluation unit. Here, the spatial arrangement or density of the electrically conductive connection on the side of the intermediate unit facing the converter element and the side of the intermediate unit facing the evaluation unit may be substantially the same. In that case, the interposer element may in particular serve to enhance the mechanical stability of the X-ray detector unit. However, the interposer element may also be of a different construction.

A variant provides for the planar extent of the evaluation unit that is arranged on an opposite side of the second stack layer to the counter-contact side to be smaller than the planar extent of an associated converter element. In this case, it is also possible for a plurality of evaluation units, for example 2 to 12 evaluation units, to be associated with one converter element. The interposer element of the second stack layer may then serve to switch the contact being made, which enables the spatial distribution of the signal lines to be changed. The second stack layer accordingly takes the form of a contact-switching plane. Here, the spatial arrangement or the density of the electrically conductive connection on the side of the intermediate unit—or the interposer element—facing the converter element, and that on the side of the intermediate unit facing the evaluation unit may differ. A smaller planar extent of the evaluation unit makes it possible to obtain a better yield from manufacture of the evaluation units, and to achieve a reduction in costs.

In a further variant of the X-ray detector unit according to at least one embodiment of the invention, the first stack layer has a plurality of converter elements arranged parallel to the second stack layer in the stack arrangement. This advantageously enables large sensor surfaces to be achieved in the X-ray detector unit. However, this can result in difficulties in making contact with the contact elements in a conventional stack construction, because the converter elements and the first and second contact elements must be positioned extremely precisely in relation to one another.

As a result of the construction of the X-ray detector unit according to at least one embodiment of the invention, by contrast, faulty contacts in the boundary regions—that is to say at points at which two converter elements abut against one another—may be avoided in a particularly advantageous manner. Advantageously, moreover, and particularly favorably, it is possible to create, within the sensor layer, small regions that are not provided for the detection of X-rays and are caused by gaps between adjacent converter elements, since these are substantially determined only by the accuracy of positioning the individual units within a stack layer, and not or only to a relatively small extent by the accuracy of positioning the stack layers and the contact elements on the converter side in relation to the contact elements on the evaluation/interposer side.

In a preferred variant of the X-ray detector unit according to at least one embodiment of the invention, the first stack layer has a plurality of converter elements and the second stack layer has an interposer element, wherein the planar extent of the interposer element spans more than one converter element of the plurality of converter elements. Advantageously, large sensor surfaces and a particularly stable stack arrangement can be ensured. In particular when an intermediate space between the first and the second stack layer is optionally filled with a filing material, it is possible to reduce or avoid the formation of potential in the converter elements, which may impair the image quality, in the region of the points of abutment.

Moreover, at least one embodiment of the invention relates to an X-ray device having an X-ray detector unit according to the invention. For example, the X-ray device may be a medical X-ray device. For example, the X-ray device comprises a mammography or an angiography X-ray device or similar. For example, the X-ray device comprises a C-frame X-ray device. The X-ray device may also comprise a computed tomography device.

The X-ray device according to at least one embodiment of the invention, for example a C-frame X-ray device, has the above-described X-ray detector unit. In this way, the X-ray device according to at least one embodiment of the invention also shares the features and advantages described above in the context of the X-ray detector unit.

Furthermore, at least one embodiment of the invention relates to a method for manufacturing an X-ray detector unit having a first stack layer and a second stack layer in a stack arrangement, wherein the first stack layer includes a converter element intended to convert incident X-rays into an electrical signal, including the steps of positioning and bringing into contact.

In the step of positioning, the first stack layer, which has first electrically conductive contact elements on a contact side, and the second stack layer, which has second electrically conductive contact elements on a counter-contact side, are positioned such that the contact side of the first stack layer and the counter-contact side of the second stack layer run parallel and facing one another. For example, the second stack layer is positioned horizontally over the first stack layer.

Here, the first contact elements have a first number density per unit surface area, and the second electrically conductive contact elements have a second number density per unit surface area, wherein the first number density is greater than the second number density. The first or the second contact elements may in this case be mounted for example by a lithographic method or mechanically.

In the step of bringing into contact, the second stack layer and the first stack layer are brought into contact such that each electrically conductive contact element of the second electrically conductive contact elements makes electrically conductive contact with a plurality of first electrically conductive contact elements.

Advantageously, the method according to at least one embodiment of the invention makes it possible to manufacture an X-ray detector unit according to at least one embodiment of the invention, having the features and advantages described above in the context of the X-ray detector unit. Advantageously, improved X-ray imaging is possible.

In a preferred variant of the method according to at least one embodiment of the invention, the bringing into contact of the second stack layer and the first stack layer is performed without soldering.

Electrical contact may be made by making a mechanical contact, for example by pressing the first and second contact elements against one another. For example, a pressure welding method may be used. As a result of dispensing with a soldering procedure between the first and second stack layer, it is possible to avoid, or at least significantly reduce, influence on a positioning tolerance as a result of displacements caused by the soldering procedure, or similar.

However, it is also possible to perform the step of bringing into contact in another way.

Moreover, in a preferred variant method, in the step of bringing into contact a mounting force is applied to the first stack layer or the second stack layer for the purpose of making the electrically conductive contact between the first stack layer and the second stack layer. For example, the first and/or the second stack layer is placed on a mounting support. The mounting force may be applied to the first or second stack layer by way of the mounting support or a further force-transmitting element such as a clamping plate or a foil. As a result of the mounting force, the first and the second contact elements may be pressed into one another. It is thus possible by way of the mounting force to make an electrically conductive connection.

The method according to at least one embodiment of the invention may moreover include arranging a plurality of converter elements to form a first stack layer. Here, arranging the plurality of converter elements within the first stack layer may be performed before the step of bringing into contact. In this variant, it is particularly advantageously possible to obtain small gaps—that is to say spacings—between adjacent converter elements of the plurality of converter elements.

The method according to at least one embodiment of the invention may moreover include the step of first forming first electrically conductive contact elements in the first number density per unit surface area on a side of the first stack layer that faces the second stack layer in the stack arrangement. Here, first contact elements may be formed on the converter elements before they are joined together to form a first stack layer. However, it is also possible for formation of the first contact elements to be performed after joining together.

The method according to at least one embodiment of the invention may moreover include the step of secondly forming second electrically conductive contact elements in the second number density per unit surface area on a counter-contact side of the second stack layer that faces the first stack layer in the stack construction, wherein the first number density is greater than the second number density.

The first or the second contact elements may in this case be mounted for example by a lithographic method or mechanically.

A preferred variant of the method according to at least one embodiment of the invention moreover includes the step of mounting an evaluation unit on an opposite side of the second stack layer to the counter-contact side. The second stack layer can in that case include an interposer element and take the form of an intermediate layer. The evaluation unit may for example be connected to the interposer element via solder connections or via an electrically conductive adhesive connection. It is possible for the step of mounting an evaluation unit to be performed before or indeed after the step of bringing into contact.

A preferred variant of the method according to at least one embodiment of the invention moreover includes the step of filling, wherein an intermediate space or indeed a plurality of intermediate spaces between the first stack layer and the second stack layer is filled with a filling material.

In the step of filling, it is possible for example to utilize a negative pressure to introduce the filling material (also called underfill) at least into the intermediate space or spaces between the first stack layer and the second stack layer. The filling material may serve to mechanically stabilize the making of contact (in particular of the pressure weld connection), in particular in the form of making an adhesive connection between the first stack layer and the second stack layer.

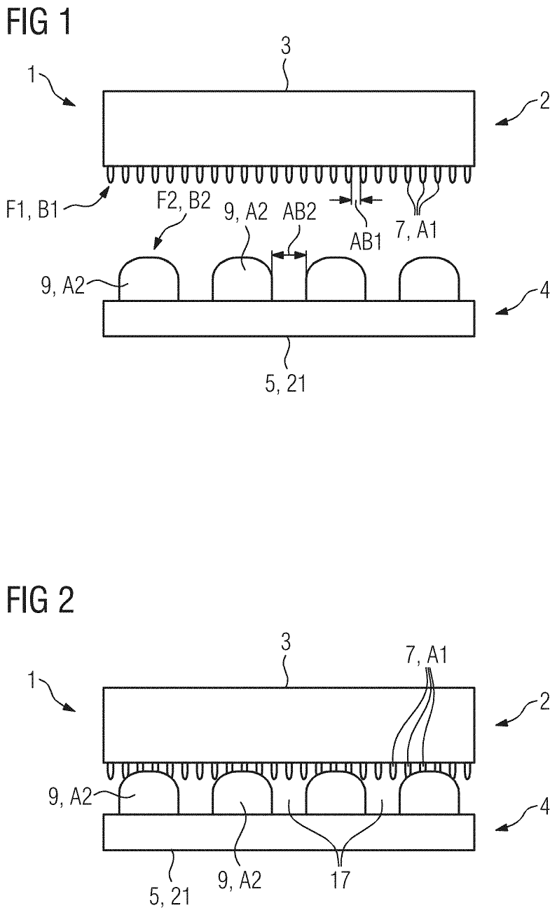

FIG. 1 shows a schematic stack arrangement of an X-ray detector unit 1 according to the invention in an embodiment in a condition of being assembled. The stack arrangement is shown in a sectional view. The X-ray detector unit 1 has a first stack layer 2 and a second stack layer 4. In the condition shown, the stack arrangement of the first stack layer 2 and the second stack layer 4 is already indicated as having a stack direction that runs parallel to the surfaces normal to the respective planar extent of the first and the second stack layer, but the stack layers 2, 4 are not yet in electrically conductive contact with one another. In the embodiment shown, the planar extent of the first stack layer 2 and the second stack layer 4 are of substantially the same size. In other embodiments, the planar extent of the stack layers may also be different.

In the embodiment shown, the first stack layer 2 includes a converter element 3. The converter element 3 takes a planar form. In the embodiment shown, the planar extent of the converter element 3 substantially corresponds to the planar extent of the first stack layer 2. The converter element 3 is intended to convert incident X-rays into an electrical signal. As converter material, there may be used for example CdTe, CZT, CdZnTeSe, CdTeSe, CdMnTe, InP, TlBr₂, HgI₂, GaAs or others. In the assembled stack arrangement of the X-ray detector unit 1, the surface normal to the planar extent of the converter element 3 typically runs substantially parallel to the direction of incidence of the X-rays in operation. Moreover, a planar electrode may be mounted on the converter element, on the side facing the direction of incidence of the X-rays, and this may serve to form an electrical field in the converter element.

In the embodiment shown, the second stack layer 4 may take the form of an evaluation unit 21 having evaluation electronics, or include an evaluation unit 21 intended to evaluate the electrical signals resulting from the absorption of X-rays in the converter element 3. However, the second stack layer 4 may also take the form of an intermediate unit between the converter element 3 and a downstream evaluation unit (not illustrated here), and include an interposer element 5. An interposer element 5 of this kind may then moreover have electrical conductor tracks that, in the stack arrangement of the X-ray detector unit 1, connect the second electrically conductive contacts 9 to the respective input channels of the downstream evaluation unit.

The first stack layer 2 has first contact elements 7 on a contact side that faces the second stack layer 4 in the stack arrangement of the X-ray detector unit 1 according to the invention. Moreover, the second stack layer 4 has second contact elements 9 on a counter-contact side of the second stack layer 4 that faces the first stack layer 2. In particular, the first contact elements 7 are provided in a first number density A1 per unit surface area and the second contact elements in a second number density A2, wherein the first number density A1 is greater than the second number density A2. For example, the first number density A1 is four to 100 times as great as the second number density A2. However, it is also possible for the number densities to be formed in a different way.

Here, each contact element of the first electrically conductive contact elements 7 has a first contact surface F1 facing the second stack layer 4, and each contact element of the second electrically conductive contact elements 9 has a second contact surface F2 facing the first stack layer 2. The contact surface of a contact element is substantially in each case the surface of the contact element that faces the respectively opposing stack layer in the stack arrangement.

In the embodiment shown, according to a preferred variant of the X-ray detector unit 1, a spacing AB1 between two first conductive contact elements 7 is smaller than a maximum width B2 of the second contact surface F2 of the second electrically conductive contact elements 9 in the direction of the spacing AB1. In this way, and particularly advantageously, it is possible to avoid not making contact or faulty contact-making by a second contact element. For example, the second contact elements 9 have a second contact surface area F2 of between 20 μm×20 μm and 220 μm×220 μm, in the present case approximately 50 μm×50 μm or 75 μm×75 μm. However, they may also take a different form.

Moreover, in the embodiment shown, according to a further preferred variant of the X-ray detector unit 1 according to the invention, a maximum width B1 of the first contact surface F1 of the first electrically conductive contact elements 7 in the direction of the spacing AB2 is smaller than the spacing AB2 between two adjacent second contact elements 9. As a result, it is advantageously possible to avoid a second contact element 9 making double contact with a first contact element 7, particularly advantageously. For example, the first contact surface F1 of a first contact element 7 is between 2 μm×2 μm and 20 μm×20 μm in size, in the present case approximately 5 μm×5 μm or 10 μm×10 μm. However, they may also take a different form.

According to a further preferred embodiment of the X-ray detector unit 1 according to the invention, in the illustration shown the first contact surface F1 of the first contact elements 7 may be smaller than the second contact surface F2 of the second contact elements 9. For example, the first contact surface F1 is one fifth to 1/200 times the size of the second contact surface F2.

Advantageously, it is possible to make a smaller gradation on the converter side by way of the first contact elements, with the result that an offset of the first stack layer in relation to the second stack layer, or of sub-units within the layers, can be identified and prevented in steps that are of this smaller gradation. Advantageously, it is likewise possible to identify and prevent inaccuracies in positioning or formation of the contact elements in steps that are of this smaller gradation.

The first and/or second contact elements may be mounted for example by lithography or mechanically. For example, the second contact elements 9 may take the form of so-called stud bumps. The second contact elements 9 may also take the form of pillars, for example so-called copper pillars, which are formed by substantially metal cylinders (or pillars). Very precise manufacture of the contact elements may be made possible by a lithographic manufacturing procedure. In particular, this also makes it possible to manufacture contact elements having a small contact surface area particularly simply. The first and/or second contact elements may for example comprise copper, gold and/or platinum.

In particular, the shape and form taken by the contact elements may differ from the shape and form illustrated schematically in FIG. 1. For example, metal cylinders that are formed may have a contact-making sphere at their free end. The contact elements may also be constructed in multiple layers.

An X-ray detector unit 1 according to an embodiment of the invention may also have further elements, in addition to the elements shown in FIG. 1. For example, an X-ray detector unit 1 according to the invention may also have further layers, for example a support unit or a substrate that is arranged in the stack arrangement on a side of the second stack layer 4 remote from the first stack layer 2.

FIG. 2 shows the stack layers of the X-ray detector unit 1 according to an embodiment of the invention that were illustrated in FIG. 1, in the assembled condition—that is to say in a stack arrangement according to the invention. The first stack layer 2 having the converter element 3 and the second stack layer 4 are oriented substantially parallel to one another in the stack arrangement. That is to say that the surfaces normal to the planar extent of the first and the second stack layer are oriented substantially parallel to one another.

In the assembled condition, each of the second electrically conductive contact elements 9 is in electrically conductive contact with a plurality of first electrically conductive contact elements 7. The electrically conductive connection, or contact-making, allows signal transfer of the electrical signals, after absorption of an X-ray quantum in the converter material, from the first stack layer 2 to the second stack layer 4 over an intermediate space 17 or a plurality of intermediate spaces 17 between the first and the second stack layer. The number of first contact elements 7 that respectively make contact with one second contact element 9 may vary for the second contact elements 9. In addition to first contact elements 7 connected to second contact elements 9, in the embodiment illustrated there are moreover also first contact elements 7 that are not electrically conductively connected to a second contact element 9 in the assembled condition.

In a preferred variant, the electrically conductive contact made between the first contact elements 7 and the second contact elements 9 is performed without soldering. Preferably, the electrical contact is made by a mechanical contact, for example by pressing the pixels and the associated contact elements against one another. As a result of dispensing with a soldering procedure between the first and second stack layer, it is possible to avoid, or at least to significantly reduce, influence on a positioning tolerance as a result of displacements caused by the soldering procedure, or similar.

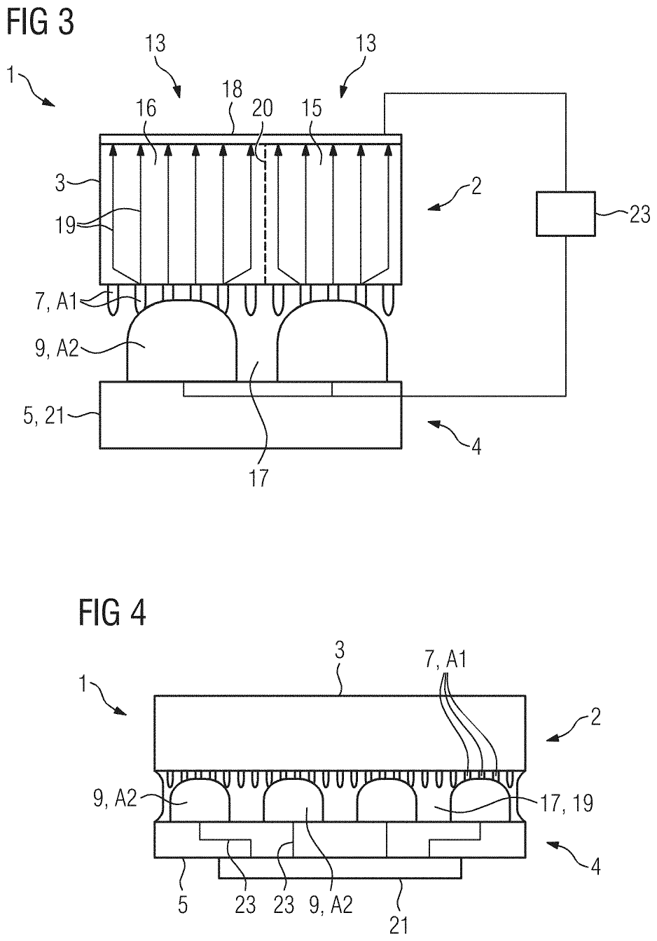

FIG. 3 shows a further schematic sectional view of a stack arrangement of an X-ray detector unit 1 according to the invention, in an advantageous embodiment. For the purpose of illustration, the detail is restricted to two second contact elements 9. This view moreover illustrates a planar electrode 18 that is mounted on an upper side of the converter element 3 of the first stack layer 2, remote from the second stack layer 4. The electrode 18 makes it possible to apply, via the power supply 23, a voltage between the upper side of the converter element 3 and the second contact elements 9 and hence also the first contact elements 7 connected thereto, such that an electrical field indicated by the arrows 19 is produced in the converter element 3. For example, a sensor voltage in the region of −1000 V may be applied to the converter element during operation of the detector unit 1 according to the invention. The electrical field serves to move the charge carriers produced by the absorption of an X-ray quantum in the converter element 3 toward the electrode 18 or the contact elements 7 (depending on whether the charge of the charge carriers or the applied voltage is negative or positive). The field lines of the electrical field are indicated here as arrows 19 that each end at first contact elements 7 that are connected to a second contact element 9.

The X-ray detector unit 1 shown has a plurality of pixels 13. In the detail shown, two pixels 13 are illustrated. Associated with each pixel in the example shown is a second contact element 9 by way of which the electrical signals produced by the interaction of an X-ray quantum with the converter material are forwarded for the purpose of evaluation. An evaluation unit connected by way of the second contact elements 9 may in this case be subdivided such that a detector element—that is to say a pixel 13—is imaged by a part-region of the evaluation unit—that is to say an ASIC pixel. Each of the second contacts 9 may in particular only be electrically conductively connected to one part-region of an evaluation unit.

The pixel volume 15, 16 in the converter element 3 that is associated with a respective pixel 13 of the detector unit 1 according to the invention, schematically delimited here by the dashed line 20, is based on the first contact elements 7 connected to a second contact element 9. Depending on the location, the pixel volume 15, 16 may vary in dependence on the respective number of first contact elements 7 that are connected to a second contact element 9. If each of the second contact elements is connected to the same number of first contact elements and there is a uniform spatial distribution of the first contact elements, it is also possible for the pixel volumes to take substantially similar forms. In the sectional view shown, however, the illustrated sectional surface of the left-hand pixel volume 16 is based, by way of example, on four connected first contact elements, and the resulting spatial field distribution of the electrical field 19.

The illustrated sectional surface of the right-hand pixel volume 15 is based on only three connected first contact elements 7 and the resulting spatial field distribution of the electrical field in the converter element 3. This can result, in the example shown, in a first smaller pixel volume 15 and a second larger pixel volume 16. These differences in the X-ray-sensitive volume of converter material that is associated with a respective pixel 13 may result in differences in pixel behavior, for example in the number of recorded counter events per pixel. However, differences of this kind between individual pixels 13 of the X-ray detector unit 1 may be compensated for, for example using calibration procedures.

FIG. 4 shows an X-ray detector unit 1 according to the invention in a further embodiment. In this embodiment, the intermediate space 17 between the first stack layer 2 and the second stack layer 4 is filled with a filling material 19.

Here, the filling material may take the form of an adhesive connecting the first stack layer 2 to the second stack layer 4 and thus serve to mechanically stabilize the contact made between the stack layers. The filling material may comprise an epoxy compound, a synthetic material, a composite material or a (pre-)polymer or another material. The filling material may comprise a binder. A matrix of binder and filler may be formed. The filling material may in particular comprise an epoxy resin. The filling material may preferably be electrically insulated or non-conductive.

Moreover, an evaluation unit 21 associated with the converter element 3 is arranged on an opposite side of the second stack layer 4 to the counter-contact side. In that case, the second stack layer 4 takes the form of an interposer element 5—that is to say an intermediate layer between the first stack layer including the converter element 3, and the downstream evaluation unit 21 associated with the converter element 3.

The evaluation unit 21 may be connected to the interposer element 5 for example via solder connections or via an electrically conductive adhesive connection.

Moreover, the second stack layer 4 has electrically conductive connections 23 between the second contact elements 9 and the respective input channels of the evaluation unit 21.

In the embodiment shown in FIG. 4, moreover, the planar extent of the evaluation unit 21 is smaller than the planar extent of the associated converter element 3. In this case, the interposer element 5 of the second stack layer 4 also serves as a contact-switching plane, which enables the signal lines to be redistributed spatially. Here, the spatial arrangement or the density of the electrically conductive connection on the side of the intermediate unit—or the interposer element 5—facing the converter element 3, and on the side of the intermediate unit 5 facing the evaluation unit 21 may differ. A smaller planar extent of the evaluation unit makes it possible in particular to reduce production costs. In other embodiments, it is also possible for a plurality of evaluation units 21 to be associated with one converter element.

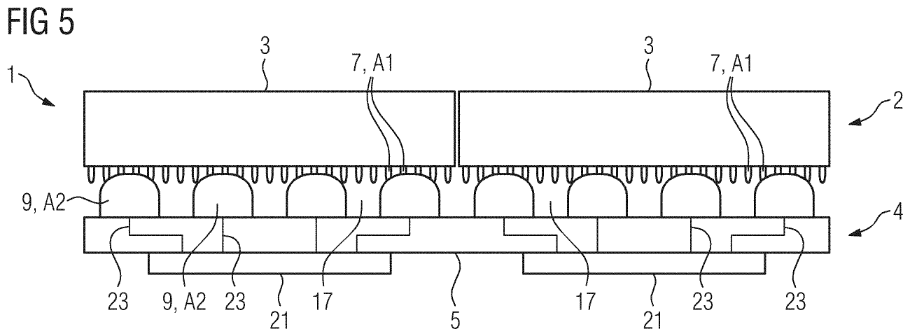

FIG. 5 shows a stack arrangement of an X-ray detector unit 1 according to the invention in a further embodiment. Here, the first stack layer 2 has a plurality of converter elements 3, in this case two converter elements 3, which are arranged parallel to the second stack layer 4 in the stack arrangement. Moreover, the second stack layer 4 has an interposer element 5. According to an advantageous embodiment of the X-ray detector unit 1 according to the invention, the planar extent of the interposer element 5 spans the planar extent of the plurality of converter elements 3. An arrangement of this kind may advantageously make a stable and improved stack arrangement possible.

According to an embodiment of the invention, the first stack layer has the first contact elements 7 in a first number density A1. Here, the term “number density A1” should be understood as the average number density in relation to the planar extent of the first stack layer. This means, in particular, that a first completed stack layer 2 may have a number density A1 that varies locally, in particular in the region of the abutment points.

The illustrated embodiment of the X-ray detector unit 1 moreover includes evaluation units 21 that are associated with the respective converter elements 3, wherein the electrically conductive connections 23 enable the transfer of signals from the second electrically conductive contact elements 9 to the respective evaluation units 21.

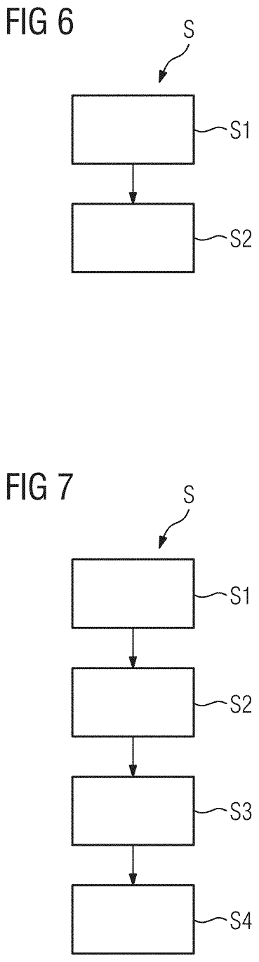

FIG. 6 schematically shows the sequence of a method S according to an embodiment of the invention for manufacturing an X-ray detector unit 1, wherein the X-ray detector unit 1 according to the invention has a first stack layer 2 that includes a converter element 3 and a second stack layer 4 in a stack arrangement.

Here, the converter element 3 is intended to convert incident X-rays into an electrical signal.

The method S according to an embodiment of the invention includes the step of positioning S1 and that of bringing into contact S2.

In the step of positioning S1, the first stack layer 2 and the second stack layer 4 are arranged in relation to one another such that a contact side of the first stack layer 2, which has first electrically conductive contact elements 7 in a first number density A1 per unit surface area, and a counter-contact side of the second stack layer 4, which has second electrically conductive contact elements 9 in a second number density A2 per unit surface area, run parallel and facing one another. Here, the first number density A1 is greater than the second number density A2. For example, the second stack layer 4 is positioned horizontally over the first stack layer 2.

In the step of bringing into contact S2, the second stack layer 4 and the first stack layer 2 are connected electrically conductively in that each electrically conductive contact element 9 of the second electrically conductive contact elements 9 is brought into electrically conductive contact with a plurality of first electrically conductive contact elements 7.

In a preferred embodiment of the method according to the invention, the bringing into contact S2 is performed without soldering. Preferably, the electrical contact is made by making a mechanical contact, for example by pressing the pixels and the associated contact elements against one another. However, it is also possible to perform the step of bringing into contact in another way.

In a preferred embodiment, in the step of bringing into contact S2 a mounting force is applied to the first stack layer 2 or the second stack layer 4 for the purpose of making the electrically conductive contact between the first stack layer 2 and the second stack layer 4. For example, the first or the second stack layer is placed on a mounting support. The mounting force may be applied to the first or second stack layer by way of the mounting support or a further force-transmitting element such as a clamping plate or a foil arranged on the first or second stack layer.

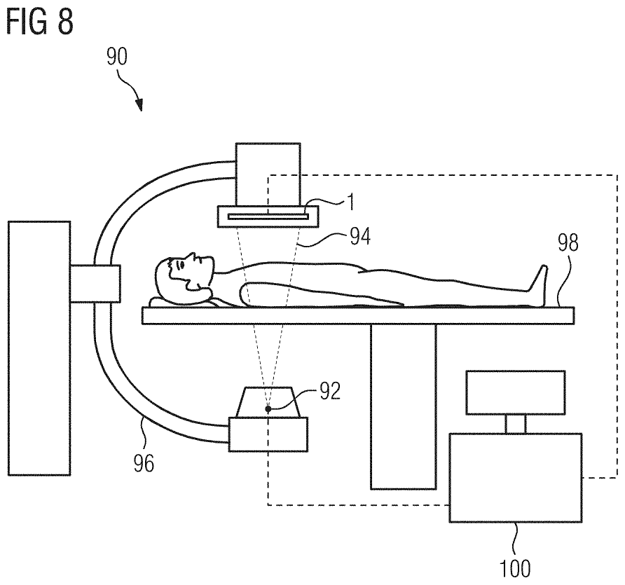

FIG. 7 schematically illustrates a variant of the method S according to an embodiment of the invention, moreover having the step of mounting S3 an evaluation unit 21 on an opposite side of the second stack layer 4 to the counter-contact side, and moreover having the step of filling S4 an intermediate space between the first stack layer and the second stack layer with a filling material 19.

The second stack layer 4 can in that case include an interposer element 5 and take the form of an intermediate layer. The evaluation unit 21 may for example be connected to the interposer element 5 via solder connections or via an electrically conductive adhesive connection. It is also possible for the step of mounting S3 an evaluation unit 21 to be performed before the step of bringing into contact S2.

In the step of filling S4, it is possible for example to utilize a negative pressure to introduce the filling material (also called underfill) at least into the intermediate space or spaces between the first stack layer and the second stack layer. The filling material is then cured. The filling material may serve to mechanically stabilize the making of contact (in particular of the pressure weld connection), in particular in the form of making an adhesive connection between the first stack layer and the second stack layer.

FIG. 8 illustrates, by way of example, a medical X-ray device 90, in the present case a C-frame X-ray device. This has an X-ray source 92 that emits X-rays 94 while the X-ray device 90 is in operation. In a position opposite the X-ray source 92, the X-ray detector unit 1 is secured to a C-frame 96 of the X-ray device 90. The X-ray source 92 and the X-ray detector unit 1 are arranged to be movable in relation to a patient table 98 via the C-frame 96. For the purpose of evaluating the X-rays detected by the X-ray detector unit 1 (in the present case measurement signals pre-processed via the ASICs evaluation unit 21), the X-ray detector unit 1 is connected to a control processor, also designated the image processing computer 100. For the purpose of controlling the X-ray source 92, the latter is also connected to the image processing computer 100.

The subject-matter of the invention is not restricted to the example embodiments described above. Rather, those skilled in the art will be able to derive further embodiments of the invention from the description above. In particular, the individual features of the invention described with reference to the different example embodiments, and their variant configurations, may also be combined with one another in other ways.

The patent claims of the application are formulation proposals without prejudice for obtaining more extensive patent protection. The applicant reserves the right to claim even further combinations of features previously disclosed only in the description and/or drawings.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

None of the elements recited in the claims are intended to be a means-plus-function element within the meaning of 35 U.S.C. § 112(f) unless an element is expressly recited using the phrase “means for” or, in the case of a method claim, using the phrases “operation for” or “step for.”

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An X-ray detector unit, comprising:
a first stack layer; and
a second stack layer, the first stack layer and the second stack layer being in a stack arrangement, wherein
the first stack layer includes a converter element to convert incident X-rays into an electrical signal,
the first stack layer includes first electrically conductive contact elements arranged on a contact side facing the second stack layer, in a first number density per unit surface area,
the second stack layer includes second electrically conductive contact elements arranged on a counter-contact side, facing the first stack layer, of the second stack layer, in a second number density per unit surface area, the first number density being relatively greater than the second number density, and
each of the second electrically conductive contact elements being configured to make electrically conductive contact with a plurality of the first electrically conductive contact elements.

2. The X-ray detector unit of claim 1, wherein each contact element of the first electrically conductive contact elements includes a contact surface facing the second stack layer, and wherein a spacing between two adjacent second electrically conductive contact elements, of the second electrically conductive contact elements, is relatively greater than a maximum width of a contact surface of the first electrically conductive contact elements in a direction of the spacing between two adjacent second electrically conductive contact elements.

3. The X-ray detector unit of claim 1, wherein each contact element of the second electrically conductive contact elements includes a contact surface facing the first stack layer, and a spacing between two adjacent first electrically conductive contact elements, of the first electrically conductive contact elements, is relatively smaller than a maximum width of the contact surface of the second electrically conductive contact elements in a direction of the spacing between two adjacent first electrically conductive contact elements.

4. The X-ray detector unit of claim 1, wherein each contact element of the first electrically conductive contact elements includes a first contact surface facing the second stack layer, and each contact element of the second electrically conductive contact elements includes a second contact surface facing the first stack layer, and wherein the first contact surface is relatively smaller than the second contact surface.

5. The X-ray detector unit of claim 1, wherein the electrically conductive contact between the first electrically conductive contact elements and the second electrically conductive contact elements is made without soldering.

6. The X-ray detector unit of claim 1, wherein an intermediate space between the first stack layer and the second stack layer is filled with a filling material.

7. The X-ray detector unit of claim 1, wherein an evaluation unit associated with the converter element is arranged on an opposite side of the second stack layer to the counter-contact side.

8. The X-ray detector unit of claim 7, wherein a planar extent of the evaluation unit is relatively smaller than a planar extent of an associated converter element.

9. The X-ray detector unit of claim 1, wherein the first stack layer includes a plurality of converter elements arranged parallel to the second stack layer in the stack arrangement.

10. The X-ray detector unit of claim 1, wherein the first stack layer includes a plurality of converter elements arranged parallel to the second stack layer in the stack arrangement, and the second stack layer includes an interposer element, wherein a planar extent of the interposer element spans more than one converter element of the plurality of converter elements.

11. An X-ray device comprising:
the X-ray detector unit of claim 1.

12. A method for manufacturing an X-ray detector unit including a first stack layer including a converter element to convert incident X-rays into an electrical signal, and a second stack layer, the first stack layer and the second stack layer being arranged in a stack arrangement, the method comprising:
positioning the first stack layer, the first stack layer including first electrically conductive contact elements on a contact side in a first number density per unit surface area, and the second stack layer, the second stack layer including second electrically conductive contact elements on a counter-contact side in a second number density per unit surface area, the first number density being relatively greater than the second number density, such that the contact side of the first stack layer and the counter-contact side of the second stack layer run parallel and face one another; and
bringing into contact the second stack layer and the first stack layer such that each electrically conductive contact element of the second electrically conductive contact elements makes electrically conductive contact with a plurality of first electrically conductive contact elements.

13. The method of claim 12, further comprising:
mounting an evaluation unit on an opposite side of the second stack layer to the counter-contact side.

14. The method of claim 12, wherein the bringing into contact of the second stack layer and the first stack layer is performed without soldering.

15. The method of claim 12, further comprising:
filling an intermediate space, between the first stack layer and the second stack layer, with a filling material.

16. The X-ray detector unit of claim 2, wherein each contact element of the second electrically conductive contact elements includes a contact surface facing the first stack layer, and a spacing between two adjacent first electrically conductive contact elements, of the first electrically conductive contact elements, is relatively smaller than a maximum width of the contact surface of the second electrically conductive contact elements in the direction of the spacing between two adjacent first electrically conductive contact elements.

17. The X-ray detector unit of claim 2, wherein each contact element of the first electrically conductive contact elements includes a first contact surface facing the second stack layer, and each contact element of the second electrically conductive contact elements includes a second contact surface facing the first stack layer, and wherein the first contact surface is relatively smaller than the second contact surface.

18. The X-ray detector unit of claim 2, wherein the electrically conductive contact between the first electrically conductive contact elements and the second electrically conductive contact elements is made without soldering.

19. The X-ray detector unit of claim 2, wherein an intermediate space between the first stack layer and the second stack layer is filled with a filling material.

20. The X-ray detector unit of claim 2, wherein the first stack layer includes a plurality of converter elements arranged parallel to the second stack layer in the stack arrangement, and the second stack layer includes an interposer element, wherein a planar extent of the interposer element spans more than one converter element of the plurality of converter elements.

21. The method of claim 13, wherein the bringing into contact of the second stack layer and the first stack layer is performed without soldering.

22. The method of claim 13, further comprising:
filling an intermediate space, between the first stack layer and the second stack layer, with a filling material.

23. The method of claim 14, further comprising:
filling an intermediate space, between the first stack layer and the second stack layer, with a filling material.
